(19) United States
(12) Patent Application Publication
(10) Pub. No.: US 2004/0194594 A1
(43) Pub. Date: Oct. 7, 2004

(54) Machine safety protection system

(76) Inventors: Jeffrey M. Dils, Simpsonville, SC (US); Philip F. Minalga, Pendleton, SC (US); William C. Buck, Clemson, SC (US)

Correspondence Address: BRINKS HOFER GILSON & LIONE, P.O. BOX 10395, CHICAGO, IL, 60610, US

(21) Appl. No.: 10/759,258

(22) Filed: Jan. 16, 2004

Related U.S. Application Data
(60) Provisional application No. 60/444,263, filed on Jan. 31, 2003.

(51) Int. Cl. B26D 1/00; B26D 3/00; B26D 5/00

(52) U.S. Cl. 83/13; 83/58; 83/DIG. 1; 83/522.12

(57) ABSTRACT

A tool safety system minimizes the likelihood of injury by detecting when a body part is in close proximity to a moving part of the tool. Upon detecting, a control system can provide one or more of moving the tool, disabling the moving part, or producing a warning signal.

The present invention relates to a safety system for a machine, particularly for a tool having a moving blade. The present invention also relates to a system to detect when a human is in close proximity to a dangerous area of the tool.

### BACKGROUND OF THE INVENTION

Machines and particularly power tools having moving parts are prevalent. Safety of the user is a paramount concern, especially when the power tool contains a moving blade, such as a saw (table saw, cut saw, chop saw, miter saw, band saw, etc.) As noted saws include blades that can move down onto or across a workpiece to cut the workpiece. Other saws include stationary blades that require the user to move a workpiece past the blade to make a cut. For example, a user of a radial arm saw draws the blade toward him as he cuts workpiece. The user typically holds the workpiece with one hand while operating the saw with his other hand. In addition, the user of a bandsaw typically uses one or both hands to slide a workpiece across a surface and past the active blade in order to cut the workpiece. Each of these situations pose the risk of direct bodily contact with a blade that can cause serious injury.

Therefore, there is a need for a device or method to address this risk. One solution is proposed in U.S. Pat. Appln. Pub. 2002/0017176 and a number of related published applications. These published applications describe a system to detect contact between the moving blade of a tool and the user and, as a result of the detecting, the motion of the blade is stopped. Although this is helpful, close proximity to a blade can pose a risk of injury. The user's clothes can be caught in the blade, or a user can be struck by the workpiece if the saw is used improperly. Therefore, there is a need for an apparatus and/or system to detect when a user is in close proximity to to the blade or a portion of the tool other than the blade such that motion of the blade can be stopped when such close proximity is detected.

### SUMMARY OF THE INVENTION

In accordance with the present invention, an apparatus and system is provided to detect whether a user, and in particular, a portion of the user's body is in close proximity to either the blade of a power tool or to a portion of the power tool such that when the close proximity is detected, the motion of the blade is stopped. In one embodiment of the present invention, a power saw safety system is provided and it includes a motor to drive a cutting blade, a protective barrier between the cutting blade and a user, a detection system coupled to the protective barrier to detect a close proximity between the user and the protective barrier and, upon detection, outputting a detecting signal; and a control system receiving the detecting signal.

In another embodiment of the present invention, a machine for cutting a workpiece is provided. The machine includes a tool having a motor to drive a blade for cutting the workpiece. The machine also includes a detection system that includes a portion of the tool, other than the blade, that is adapted to function as a capacitive probe to search for a preselected capacitance level and, when the preselected capacitance level is located, the detection system outputs a detecting signal. The machine may further include a control system adapted to cause a predetermined action to take place upon receipt of the detecting signal.

In another aspect of the present invention, a method of minimizing the risk of injury to a user of a cutting tool is provided. The method includes detecting a close proximity between the user and a portion of the cutting tool which may or may not include the cutting blade and selectively providing a warning signal or stopping motion of the saw blade, upon detecting the close proximity.

In another aspect of the present invention a method of detecting close proximity to a tool having a motor to drive a blade is provided. The method includes providing a capacitive probe on a portion of the tool other than the blade; and, sensing whether a user is in close proximity to the probe by detecting a capacitance of the user.

In yet another aspect of the present invention a method of providing a safety system on a power tool that has a motor to drive a blade is provided. This method includes providing a capacitive probe on a portion of the tool other than the blade, wherein the probe detects the presence of a portion of a user's body when that portion is in close proximity to the portion of the tool; and, providing a control system to receive a signal from the capacitive probe indicative of the presence of a portion of a user's body in close proximity to the portion of the tool, wherein the control system is adapted to selectively provide a warning signal or a stopping motion of the blade.

### BRIEF DESCRIPTION OF THE DRAWINGS

FIG. 1 is a schematic block diagram of one embodiment of the machine safety system of the present invention.

FIG. 2 is a schematic diagram of one embodiment of the safety system in the context of a power saw.

FIG. 3 is a diagram of a digital capacitive circuit useful in the safety system of the present invention.

FIG. 4 is a circuit diagram of a motor that incorporates features of the safety system of the present invention and showing the motor in the normal run mode.

FIG. 5 is a circuit diagram of a motor that incorporates features of the safety system of the present invention and showing the motor in a stopped or “off” position.

FIG. 6 is a portion of a circuit diagram that incorporates features of the safety system of the present invention being implemented on a miter saw and showing the miter saw in a stopped or “off” position.

FIG. 7 is a portion of a circuit diagram that incorporates features of the safety system of the present invention being implemented on a miter saw and showing the miter saw in a stopped or “off” position.

FIG. 8 is a portion of a circuit diagram that incorporates features of the safety system and shows the state when the motor is commutated (i.e., when the amplifier circuit reverses the circuit in the motor to decelerate the motor).

FIG. 9 is an exemplary process control board and a portion of a circuit to be connected with the board where the circuit incorporates features of the safety system.

FIG. 10 perspective view of one embodiment of a machine according to the present invention and in particular, a perspective view of a table saw that incorporates features of the safety system.

FIG. 11 is a side view of a table saw that includes a protective barrier and a capacitive probe mounted on a portion of the barrier. The figure also shows a portion of the safety system and, in particular, the circuit board with the housing removed to better show the components.

FIG. 12 is a side perspective view of a table saw that includes a protective barrier and a capacitive probe mounted on a portion of the barrier.

FIG. 13 is a perspective view of a motor to drive a blade with a portion of the motor housing removed to show the connection of the motor with a portion of the safety system and, in particular, the circuit board with the housing removed to better show the components.

FIG. 14 shows a portion of the safety system and, in particular, the circuit board with the housing removed to better show the components.

### DESCRIPTION OF THE INVENTION

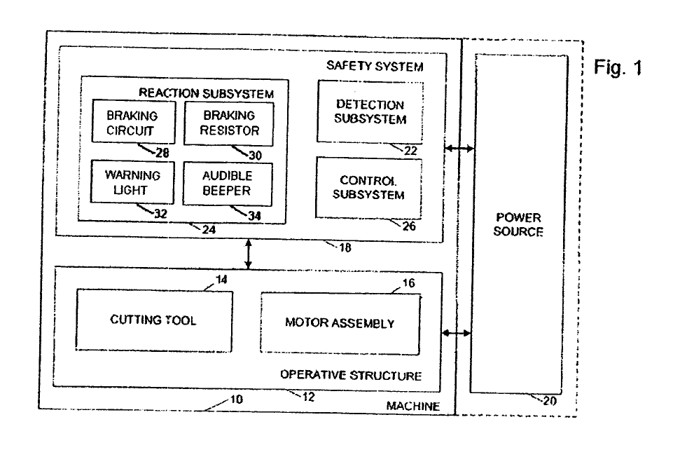

A machine that may incorporate a safety system according to the present invention is shown schematically in FIG. 1 and indicated generally at 10. The machine 10 may be any of a variety of different machines adapted for cutting workpieces, such as wood, including a table saw, miter saw, radial arm saw, circular saw, band saw, jointer, planer, etc. The machine 10 includes an operative structure 12 having a cutting tool 14 and a motor assembly 16 adapted to drive the cutting tool 14. The machine 10 also includes a safety system 18 configured to minimize the potential of a serious injury to a person using the machine 10. The safety system 18 is adapted to detect the close proximity between a portion of the human body and the cutting tool 14. In particular, the safety system 18 is adapted to detect when the human body is in close proximity to a portion of the cutting tool 14 that is not the blade. The portion of the cutting tool may be a protective barrier 44 provided on a portion of the cutting tool 14. When the safety system detects that a portion of the human is in close proximity to the portion of the cutting tool, the safety system 18 is adapted to stop the motion of the blade such as by disabling the operative structure 12.

The machine 10 includes a suitable power source 20 to provide power to the operative structure 12 and the safety system 18. The power source 20 may be an external power source such as line current, or an internal power source such as a battery. Alternatively, the power source 20 may include a combination of both external and internal power sources. Furthermore, the power source 20 may include two or more separate power sources, each adapted to power different portions of the machine 10.

It will be appreciated that the operative structure 12 may take any one of many different forms, depending on the type of machine 10. For example, the operative structure 12 may include a stationary housing configured to support a motor assembly 16 in driving engagement with a cutting tool 14. Alternatively, the operative structure 12 may include a movable structure configured to carry a cutting tool 14 between multiple operating positions. As a further alternative, the operative structure 12 may include one or more transport mechanisms adapted to convey a workpiece toward and/or away from the cutting tool 14.

The motor assembly 16 includes one or more motors adapted to drive the cutting tool 14. The motor assembly 16 may be either directly or indirectly coupled to the cutting tool, and may also be adapted to drive workpiece transport mechanisms. The cutting tool 14 typically includes one or more blades or other suitable cutting implements that are adapted to cut or remove portions from the workpieces. The particular form of the cutting tool 14 will vary depending upon the various embodiments of the machine 10. For example, in table saws, miter saws, circular saws and radial arm saws, the cutting tool 14 will typically include one or more circular rotating blades having a plurality of teeth disposed along the edge of the blade. For a jointer or planer, the cutting tool typically includes a plurality of radially spaced-apart blades. For a band saw, the cutting tool includes an elongate, circuitous tooth-edged band. It can be appreciated by one skilled in the art that the safety system 18 of the present invention can be used in conjunction with any type of power saw used for cutting. Furthermore, the safety system 18 can be easily retrofitted onto machines not previously having such a system.

The safety system 18 includes a detection subsystem 22, a reaction subsystem 24, and a control subsystem 26. The control subsystem 26 may be adapted to receive inputs from a variety of sources including the detection subsystem 22, the reaction subsystem 24, the operative structure 12, and the motor assembly 16. The control subsystem 26 may also include one or more sensors adapted to monitor selected parameters of the machine 10. In addition, control subsystem 26 typically includes one or more instruments operable by a user to control the machine. The control subsystem is configured to control the machine 10 in response to the inputs it receives.

Detection subsystem 22 is configured to detect when the human body is in danger of injury during use of the machine 10. When such is detected, the detection subsystem 22 creates an output detection signal. For example, the detection subsystem 22 may be configured to detect when a user's hand is extremely close to a cutting blade 40. In another example, the detection subsystem 22 may be configured to detect the rapid movement of a workpiece due to kickback by the cutting tool. In some embodiments, the detection subsystem 22 may inform the control subsystem 26 of the dangerous condition, which then activates reaction subsystem 24. In other embodiments, the detection subsystem 22 may be adapted to activate the reaction subsystem 24 directly.

Once activated in response to a dangerous condition, reaction subsystem 24 is configured to disable the operative structure 12 quickly to prevent serious injury to the user. The reaction subsystem 24 may be configured to do one or more of the following: stop the movement of cutting tool 14, disconnect motor assembly 16 from power source 20, retract the cutting tool from its operating position, reverse the current in the motor assembly 16, or the like. The reaction subsystem may be configured to take a combination of steps to protect the user from serious injury. It can be appreciated by one skilled in the art that the reaction subsystem can be configured in a variety of ways to prevent or at least minimize the likelihood of injury to the user.

The configuration of the reaction subsystem 24 will vary depending on which action(s) are taken. In the preferred embodiment depicted in FIG. 1, the reaction subsystem 24 is configured to stop the movement of the cutting tool 14 as well as provide warning to the user, and includes a braking circuit 28, braking resistor 30, warning light 32, and an audible beeper 34. The braking circuit is adapted to disable the operative structure 12 by inserting a braking resistor 30 in series with the armature coil of the motor assembly 16. During operation of machine 10, there is no added resistance impeding the flow of current through the armature coil of the motor assembly 16. However, when an activation signal is received by the reaction subsystem 24, the warning light 32, audible beeper 34, and the braking circuit 28 are activated. When activated, the braking resistor 30 resists the current that induces electromotive force to the motor assembly 16, thereby stopping the cutting tool 14.

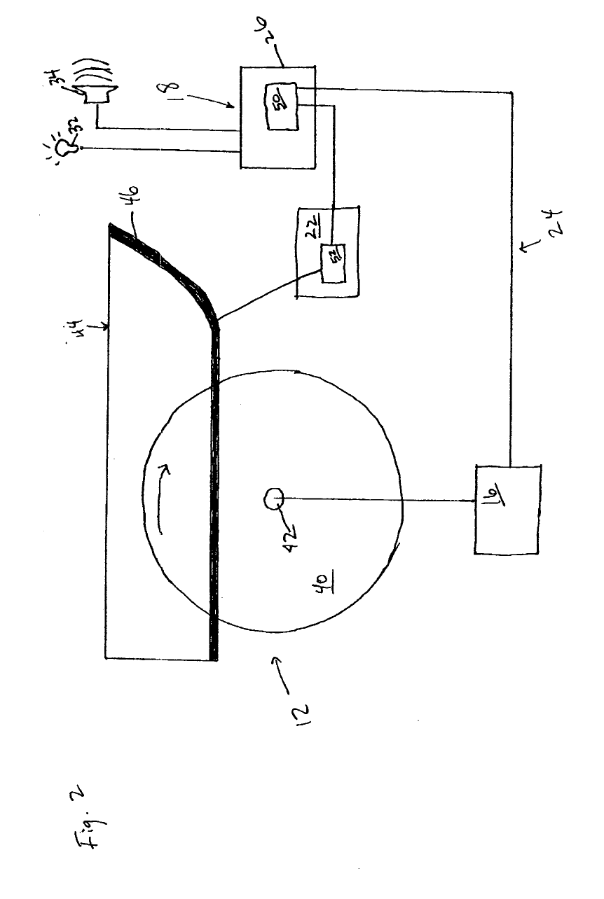

It will be appreciated by those of skill in the art that the preferred embodiment depicted in FIG. 1 and described above may be implemented in a variety of ways depending on the type and configuration of operative structure 12. In FIG. 2, one example of the many possible implementations of safety system 18 is shown. System 18 is configured to disable an operative structure 12 having a cutting blade 40, in the form of a circular blade, mounted on a rotating shaft or arbor 42. Blade 40 includes a plurality of cutting teeth (not shown) disposed around the outer edge of the blade.

In the preferred embodiment, the safety system 18 includes a blade guard located substantially adjacent to the cutting blade 40, and a warning signal sufficient to warn the user of a possibility of injury. Blade guards 44 are generally made of a transparent plastic or polymeric material, and are placed in a position to protect the user from contacting the cutting blade 40 as well as a means of containing splinters from the cutting process. Blade guards 44 act as barriers between the exposed blade 40 and the user, so as to prevent contact between a body part and a moving blade 40. Often, blade guards 44 are moveable, and can provide the user with direct access to the blade or the throat plate 72.

Throat plates 72 are also used to minimize a user's exposure to a cutting blade 40. A throat plate 72 is generally located atop a working surface 70, and the cutting blade 40 is inserted from the bottom of the working surface 70 and through the throat plate. The throat plate 72 acts to expose only enough of the cutting blade 40 to fully cut a workpiece, and also to provide lateral support to the cutting blade 40 so as to prevent the blade from bending. When the blade of a power saw bends, the cut is not precise, and can lead to kickback from a workpiece.

It can be understood by one skilled in the art that the safety system 18 can have a variety of configurations sufficient to prevent direct contact between the user and a moving blade.

Detection subsystem 22 is configured to detect when the human body is in danger of injury during use of the machine 10. When such is detected, the detection subsystem 22 is activated. For example, the detection subsystem 22 may be configured to detect when a user's hand is extremely close to a cutting blade 40. In another example, the detection subsystem 22 may be configured to detect the rapid movement of a workpiece due to kickback by the cutting tool. In some embodiments, the detection subsystem 22 may inform the control subsystem 26 of the dangerous condition, which then activates reaction subsystem 24. In other embodiments, the detection subsystem 22 may be adapted to activate the reaction subsystem 24 directly.

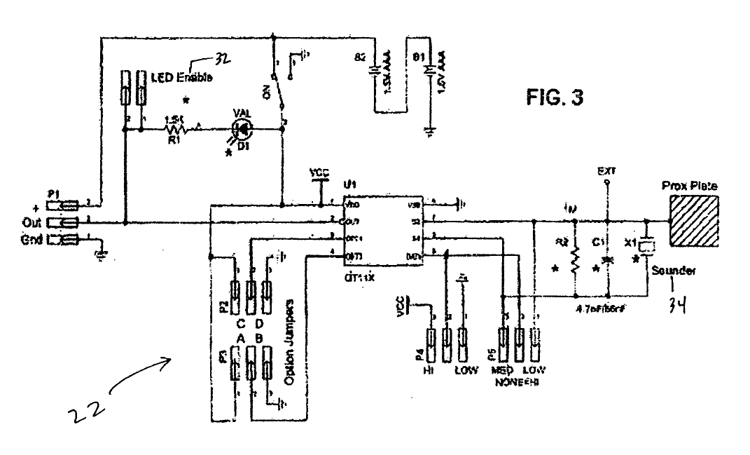

The preferred embodiment of the detection subsystem 22 has a sensor 46 coupled to the blade guard 44. The sensor 46 is preferably a metal strip adhered to the inside and/or outside surface of the blade guard 44 near the edge of the blade guard adjacent to the working surface 70. The sensor 46 is connected to a digital capacitive circuit 52. An example of such a circuit is the Qprox manufactured by Quantum Research Group, as shown in FIG. 3. The combination of the digital capacitive circuit 52 and the sensor 46 creates a capacitive probe which searches for a particular capacitance level. The level and sensitivity of the capacitive probe is adjustable by gain adjustments in the digital capacitive circuit. Preferably, the capacitive probe is set to sense when a human is extremely close to or in contact with the sensor 46, the blade 40, a throat plate 72, or any other dangerous area surrounding the blade 40. The sensitivity of the digital capacitive circuit 52 should be set to detect a capacitance of about 100 picofarads, which is the capacitance created by human contact with, or a body part in close proximity to, a sensor 46. The detection subsystem 22 is capable of sensing the proximity or contact of a human with the sensor 46, regardless of whether or not the user is wearing protective gloves or the like. When human contact or close proximity with a dangerous area is detected, a detection signal is output to the control system 26.

It can be understood to those skilled in the art that the detection subsystem 22 can have a variety of configurations capable of detecting when the user is either in contact or close proximity to a dangerous area of the machine 10, including the blade guard 44, blade 40, throat plate 72, or another surface near the blade 40. It can be further understood by those skilled in the art that the sensors 46 can be made of any material sufficient to detect a situation in which the user is either in close proximity or in direct contact with the blade, blade guard, or other dangerous area near the blade.

The control subsystem 26 includes one or more instruments (not shown) that are operable by a user to control the blade 40. The instruments may include start/stop switches, speed controls, direction controls, etc. Control subsystem 26 also includes a logic controller 50 connected to receive the user's inputs via the various instruments. Logic controller 50 is also connected to receive a detection signal from detection subsystem 22. Further, the logic controller 50 may be configured to receive inputs from other sources (not shown) such as blade motion sensors, workpiece sensors, etc. In any event, the logic controller 50 is configured to control the operative structure 12. However, upon receipt of a detection signal from detection subsystem 22, the logic controller 50 can cause the reaction subsystem 24 to activate an audible beeper 34, a warning light 32, disable the blade 40, or a combination thereof. It can be recognized by one skilled in the art that there are a variety of actions sufficient to either provide the user with a warning signal or to disable the cutting blade.

The preferred embodiment of the control subsystem 26 involves disabling the cutting blade 40 upon receipt of a detection signal from the detection subsystem 22 in which a user is in close proximity or in contact with the blade 40, blade guard 46, throat plate 72, or any other dangerous area near the blade 40. The control subsystem 26 contains a logic controller 50 which is adapted to receive multiple inputs. The logic controller 50 has a predetermined response to the inputs received. In particular, the logic controller 50 will activate various features of the reaction subsystem 24 depending on the detection signal received from the detection subsystem 22. In one embodiment of the control subsystem 26, an output signal or series of signals activates at least one element within the reaction subsystem 24.

In another embodiment of the control subsystem 26, when a detection signal is received from the detection subsystem 22, electrical power to the motor 16 is disconnected. Without power to run the motor, the blade will be disabled. In a further embodiment, the control subsystem 26 includes an amplifier circuit designed to cause a commutation of the motor. In other words, the current supplied to the motor 16 is reversed, thereby decelerating the motor 16 driving the cutting blade 40 rapidly. It can be understood by one skilled in the art that the control subsystem 26 can be configured in a variety of ways sufficient to prevent injury to the user during operation of a power saw.

In the preferred embodiment of the reaction subsystem 24, the signal received from the logic controller 50 can cause the reaction subsystem 24 to disable the cutting blade 40, activate a warning light 32 or audible sound 34, or effectuate any combination thereof rapidly. When the logic controller 50 outputs a signal to the reaction subsystem to activate the braking circuit 28, the braking circuit activates a braking resistor 30 to insert a resistance in series with the armature coil of the motor assembly 16. The logic controller 50 can also send a signal to the reaction subsystem 24 to provide the user with a warning signal that a body part is dangerously close to the blade 40, blade guard 44, throat plate 72, or another dangerous area near the blade 40.

The warning signal can include a warning light 32, an audible sound 34, or any variety of signals that can be sensed by the user to indicate a dangerous condition. A warning light 32 is preferably located on the blade guard 44 in order to produce a visual warning of danger, but can be located at any other location sufficient to provide the user with a visual warning of danger. The warning light 32 can be an LED display which, when activated, displays a textual warning. In another embodiment, the warning light 32 can be a light bulb which is illuminated. In a further embodiment, the warning light 32 can consist of a flashing light. The audible sound 32 provides the user of the power saw with a sufficient auditory warning of a dangerous situation. These warning signals can be activated by the logic controller 50 simultaneously, individually, or consecutively, depending upon the signal received from the logic controller 50. In addition, the operative structure 12 need not be in the operative mode in order for a warning signal to be activated. Thus, even when the motor is off and the blade is stopped, a warning signal can be activated when a user is in close proximity or in contact with the blade 40, blade guard 44, throat plate 72, or any other dangerous area in the vicinity of the cutting blade 40. It can be appreciated to one skilled in the art that a variety of warning signal(s) can be used to provide the user with a warning sufficient for the user to appreciate a dangerous condition.

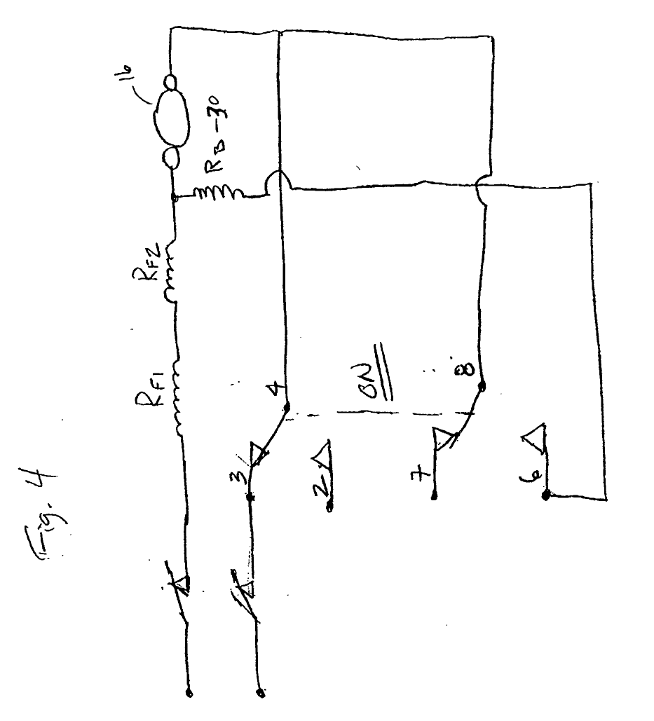

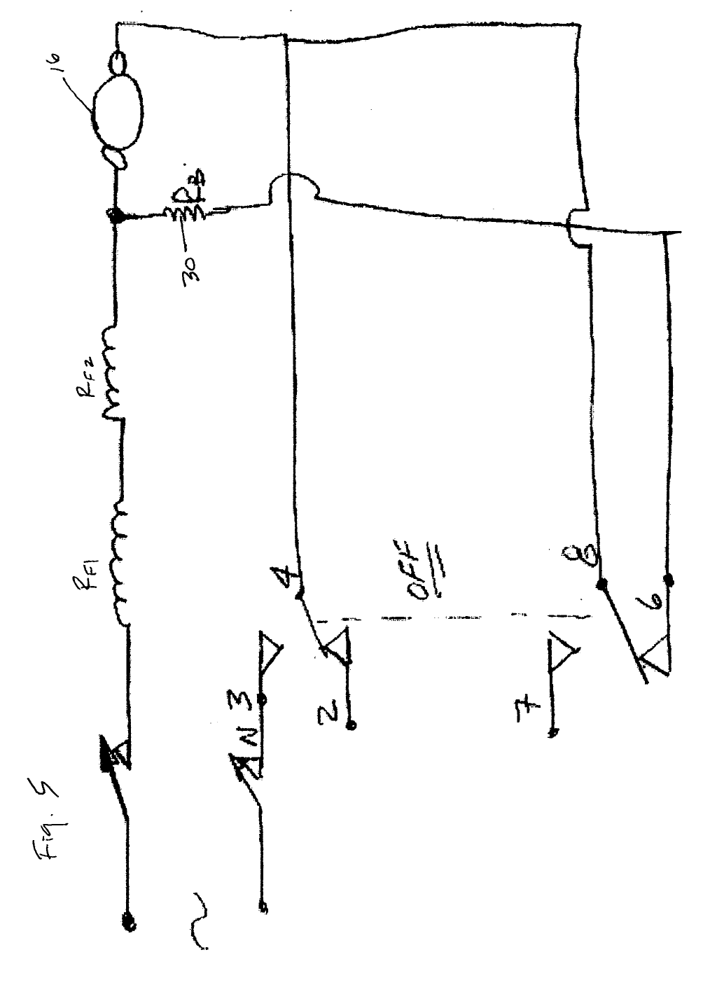

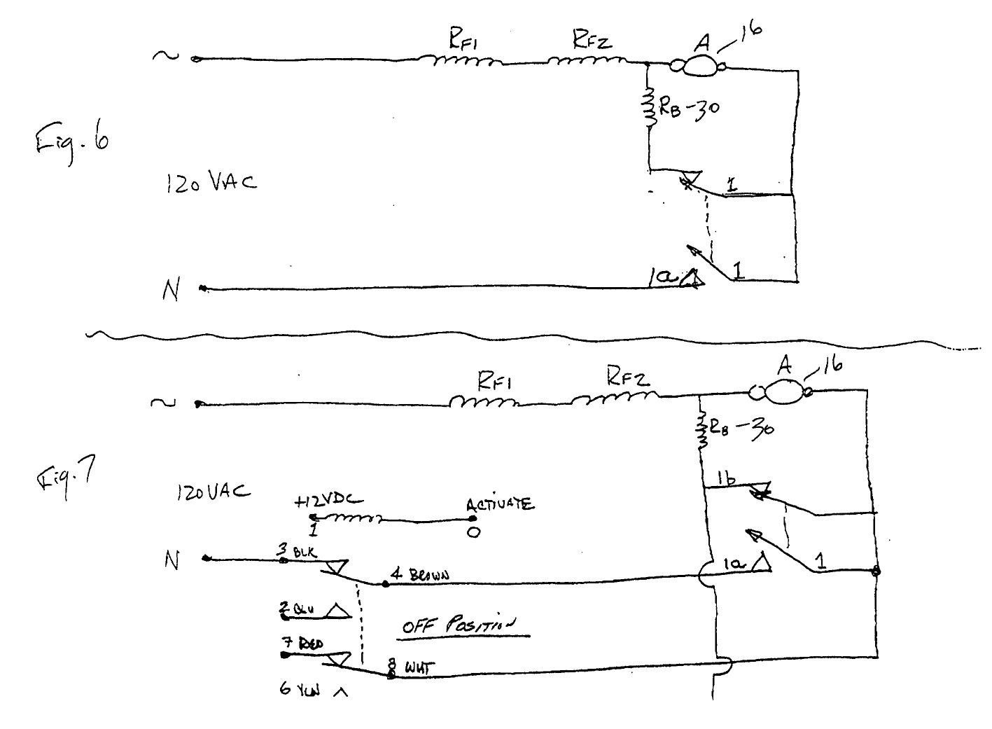

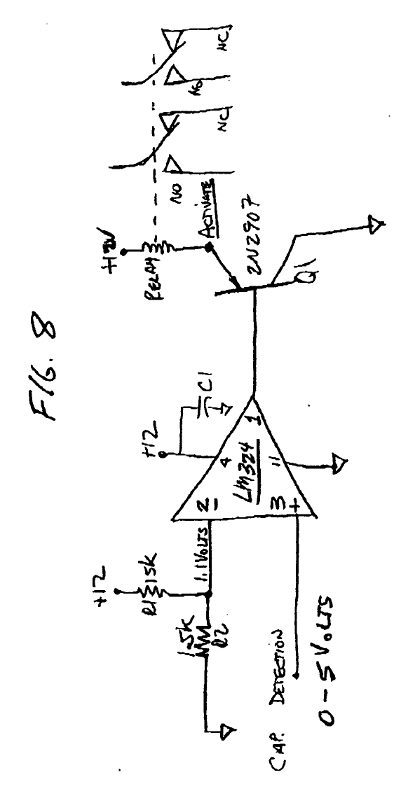

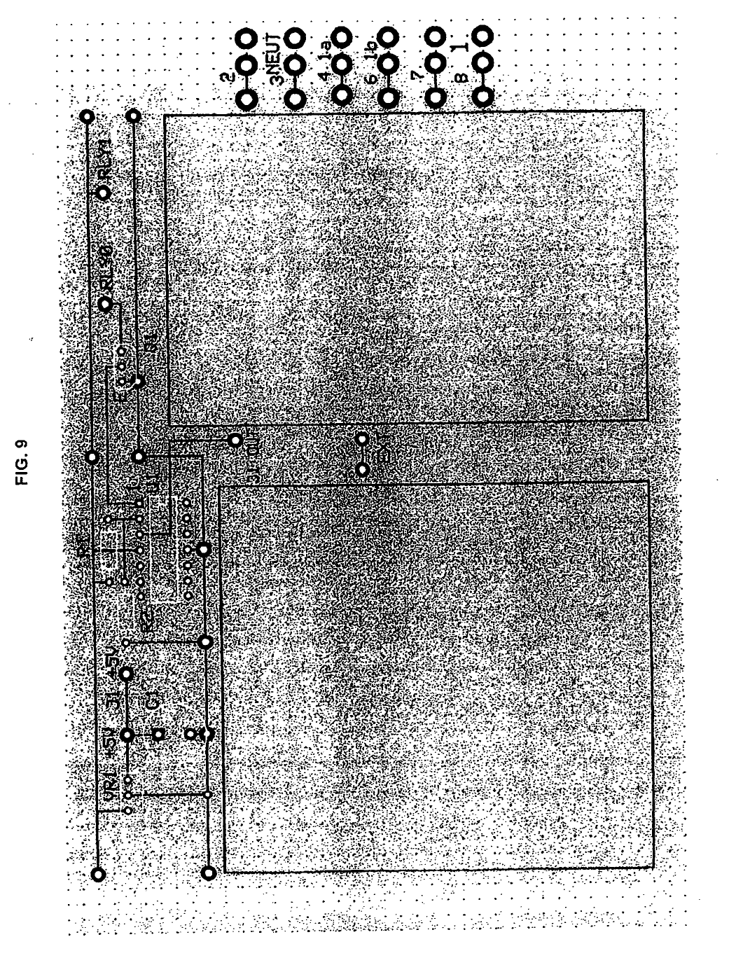

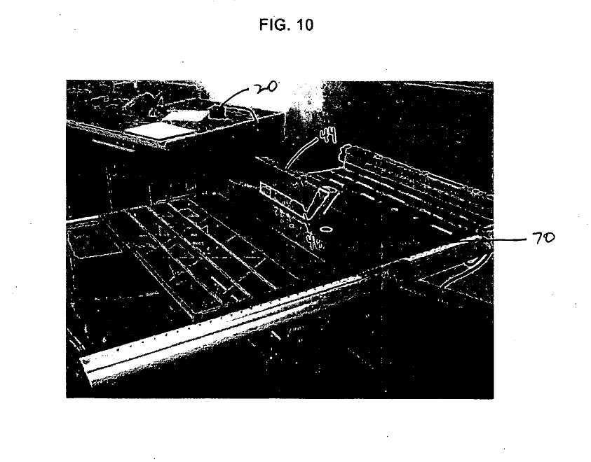

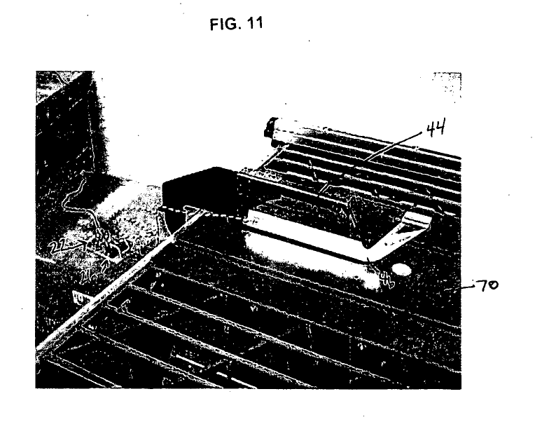

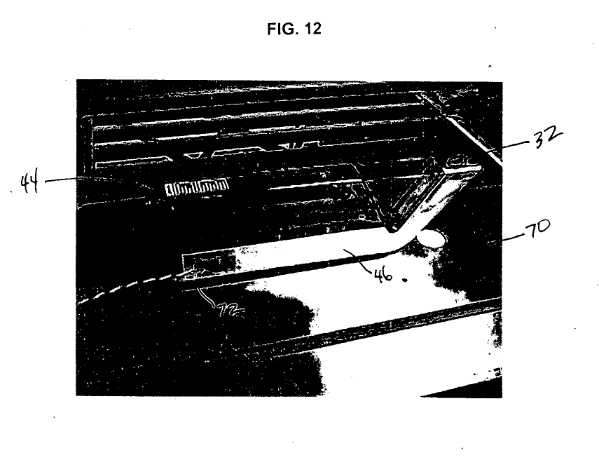

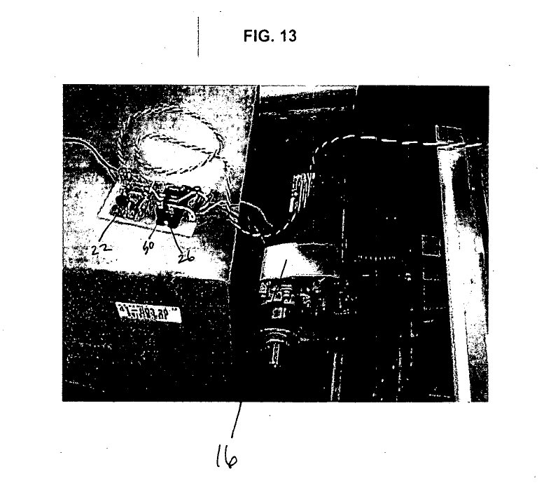

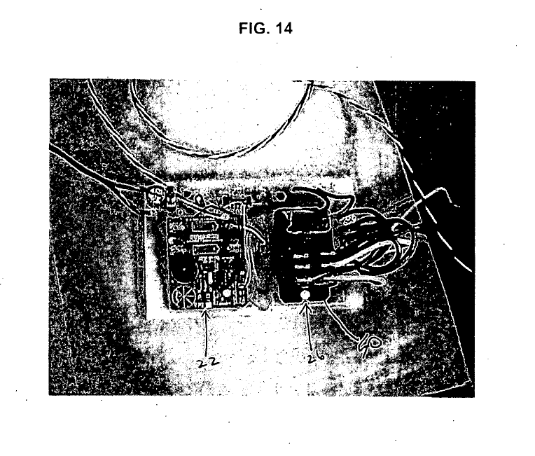

The circuit diagrams of FIGS. 4-9 represent a variety of braking circuits 28 which can be used to disable the blade 40 by effecting the operating condition of the motor 16. For example, FIG. 4 is the preferred embodiment of the circuit for the motor in a normal run mode. When there are no dangers posed by the user, the motor is free to drive a cutting blade. The diagram in FIG. 5 is the result of a detection signal being received by the control subsystem 26. When the detection signal is received from the detection subsystem 22, the circuit to the motor is closed, thereby preventing the motor from driving the blade 40, thereby disabling the operation of the blade 40 almost instantaneously. The circuit diagrams in FIGS. 6 and 7 represent the circuits in combination with a miter saw in the off positions. The circuit diagram of FIG. 8 represents the situation in which the control subsystem 26 receives a detection signal from the detection system 22 indicating the user is in contact or in close proximity to the blade 40, blade guard 44, or any dangerous area near the blade 40. In this embodiment, the control subsystem 26 reverses the electrical current to the motor thereby decelerating the motor at a rapid rate. It can be understood by one skilled that there are a variety of braking circuits sufficient to have an effect on the motor so as to disable the cutting blade. FIG. 9 is a circuit diagram of the board to which the detection subsystem 22 and the control subsystem 26 are mounted and connected.

It is therefore intended that the foregoing detailed description be regarded as illustrative rather than limiting, and that it be understood that it is the following claims, including all equivalents, that are intended to define the spirit and scope of this invention.

1. A power saw safety system comprising:
a. a motor configured to drive a cutting blade;
b. a protective barrier between the cutting blade and a user;
c. a detection system coupled to the protective barrier to detect a close proximity between the user and the protective barrier and, upon detection, outputting a detecting signal; and
d. a control system receiving the detecting signal.

2. The power saw safety system of claim 1 wherein the protective barrier is a blade guard.

3. The power saw safety system of claim 1 wherein the protective barrier is a throat plate.

4. The power saw safety system of claim 1 wherein the detection system detects a capacitance of the user.

5. The power saw safety system of claim 1 wherein the detection system comprises a digital capacitive circuit that senses the capacitance of the user.

6. The power saw safety system of claim 5 wherein the digital capacitive circuit is configured to sense a capacitance in the range from about 1 picofarad to about 500 picofarad.

7. The power saw safety system of claim 5 wherein the digital capacitive circuit is configured to sense a capacitance in the range from about 50 picofarad to about 200 picofarad.

8. The power saw safety system of claim 5 wherein the digital capacitive circuit is configured to sense a capacitance of about 100 picofarad.

9. The power saw safety system of claim 5 wherein the digital capacitance circuit includes a capacitor selected from the group consisting of ceramic, film, power film, aluminum, and tantalum.

10. The power safety system of claim 1 wherein the protective barrier functions as a capacitive probe to search for a selectable capacitance level.

11. The power saw safety system of claim 1 wherein the control system is adapted to stop motion of the cutting blade upon receiving the detecting signal.

12. The power saw safety system of claim 1 wherein the control system includes a braking resistor operative with the motor to stop motion of the cutting blade.

13. The power saw safety system of claim 12 wherein the control system is adapted to insert the braking resistor in series with an armature coil of the motor, thereby stopping motion of the cutting blade.

14. The power saw safety system of claim 1 wherein the control system includes an amplifier circuit to reverse current in the motor, thereby stopping motion of the cutting blade.

15. The power saw safety system of claim 1 wherein the control system is adapted to disable the cutting blade when the cutting blade is in an active mode.

16. The power saw safety system of claim 1 wherein the control system is adapted to provide a warning signal upon receiving the detecting signal.

17. The power saw safety system of claim 16 wherein the warning signal is a light.

18. The power saw safety system of claim 16 wherein the warning signal is an audible sound.

19. The power saw safety system of claim 1 wherein the control system is adapted to disconnect electrical power to the motor.

20. The power saw safety system of claim 1 wherein the control system is adapted to move the cutting blade away from a cutting area.

21. The power saw safety system of claim 1 wherein the control system is selectively adapted to provide a warning signal, to stop motion of the cutting blade, or move the cutting blade away from a cutting area, upon receiving the detecting signal.

22. The power saw safety system of claim 21 wherein the control system provides a warning signal and stops motion of the cutting blade.

23. The power saw safety system of claim 22 wherein the control system simultaneously provides a warning signal and stops motion of the cutting blade.

24. The power saw safety system of claim 1 wherein upon receiving the detecting signal, the control system is selectively adapted to provide at least two simultaneous actions selected from the group consisting of providing a warning signal, stopping motion of the cutting blade, and moving the cutting blade away from a cutting area.

25. A method of minimizing the risk of injury to a user of a power saw, where the power saw includes a moving cutting blade, the method comprising:
a. providing a protective barrier between the cutting blade and the user;
b. detecting a close proximity between the user and the protective barrier; and
c. selectively providing a warning signal or stopping motion of the saw blade, upon detecting the close proximity.

26. A method of minimizing the risk of injury to a user of a cutting tool, were the cutting tool includes a moving cutting blade, the method comprising:
a. detecting a close proximity between the user and a portion of the cutting tool not including the cutting blade; and
c. selectively providing a warning signal or stopping motion of the saw blade, upon detecting the close proximity.

27. A machine for cutting a workpiece comprising:
a. a support structure having a cutting area;
b. a motor to drive a cutting tool having a blade, wherein the cutting tool is associated with the support structure and adapted to move at least partially into the cutting area to cut the workpiece;
c. a detection system to detect close proximity between a user and a selected portion of the cutting tool that does not include the blade; and,
d. a control system adapted to stop motion of the cutting tool upon detection of close proximity by the detection system.

28. The machine of claim 27, where the motor rotates the cutting tool as the cutting tool moves at least partially into the cutting zone, and where the control system is adapted to stop the rotation of the cutting tool.

29. The machine of claim 28 where the control system includes a first brake mechanism adapted to stop the movement of the cutting tool into the cutting area, and a second brake mechanism adapted to stop the rotation of the cutting tool.

30. The machine of claim 27, further comprising an operative structure adapted to couple the cutting tool to the support structure, where the operative structure is selectively movable relative to the support structure to move the cutting tool into the cutting area, and where the control system is adapted to stop movement of the operative structure relative to the support structure upon detection of close proximity by the detection system.

31. The machine of claim 26 further comprising a blade guard and wherein the selected portion of the tool is the blade guard.

32. The machine of claim 30 wherein the machine is an up-cut saw and wherein the control system is adapted to stop upward movement of the operative structure.

33. A machine for cutting a workpiece comprising:
a. a tool having a motor to drive a blade for cutting the workpiece; and,
b. a detection system that includes a portion of the tool other than blade adapted to function as a capacitive probe to search for a preselected capacitance level and when the preselected capacitance level is located the detection system outputs a detecting signal.

34. The machine of claim 33 further comprising a control system adapted to cause a predetermined action to take place upon receipt of the detecting signal.

35. A method of detecting close proximity to a tool having a motor to drive a blade comprising:
a. providing a capacitive probe on a portion of the tool other than the blade; and,
b. sensing whether a user is in close proximity to the probe by detecting a capacitance of the user.

36. A method of providing a safety system on a power tool having a motor to drive a blade, comprising:
a. providing a capacitive probe on a portion of the tool other than the blade, wherein the probe detects the presence of a portion of a user's body when that portion is in close proximity to the portion of the tool; and,
b. providing a control system to receive a signal from the capacitive probe indicative of the presence of a portion of a user's body in close proximity to the portion of the tool, wherein the control system is adapted to selectively provide a warning signal or a stopping motion of the blade.
